(19) United States
(12) Patent Application Publication
(10) Pub. No.: US 2026/0265010 A1
(43) Pub. Date: Sep. 10, 2026

(54) MEDIUM STACKING DEVICE

(71) Applicant: SEIKO EPSON CORPORATION, Tokyo (JP)

(72) Inventors: Taiki NISHI, MATSUMOTO-SHI (JP); Kazuo OTSUKA, AZUMINO-SHI (JP); Shun ITO, MATSUMOTO-SHI (JP); Yosuke NAKANO, MATSUMOTO-SHI (JP)

(21) Appl. No.: 19/554,063

(22) Filed: Mar. 2, 2026

(30) Foreign Application Priority Data
Mar. 5, 2025 (JP) 2025-034366

(51) Int. Cl. B65H 11/00

(52) U.S. Cl. CPC B65H 11/00; B65H 2301/421; B65H 2402/20

(57) ABSTRACT

A medium stacking device includes a stacking portion that stacks a medium by a support surface, a pressing portion that presses the medium from above, and an upper unit that holds the pressing portion and is displaceable between a first open state and a second open state and a closed state, wherein the upper unit includes a convex portion and an arm configured to maintain the first open state and the second open state, the stacking portion has a cam groove that guides the convex portion, through which the convex portion moves when the upper unit is displaced between the first open state and second open state and the closed state, the cam groove is provided with a first concave portion that supports the convex portion from below and maintains the upper unit in the first open state, and a second concave portion that maintains the upper unit in the second open state at a position lower than that in the first concave portion, and the second concave portion has higher acceptability than the first concave portion with respect to an impact from the convex portion.

The present application is based on, and claims priority from JP Application Serial Number 2025-034366, filed Mar. 5, 2025, the disclosure of which is hereby incorporated by reference herein in its entirety.

### BACKGROUND

### 1. Technical Field

The present disclosure relates to a medium stacking device.

### 2. Related Art

In related art, an apparatus including an opening and closing mechanism has been known. For example, JP-A-2020-55248 discloses a recording apparatus including an upper unit that can be opened and closed with respect to a lower unit. The opening and closing mechanism of the apparatus can hold the upper unit in a first open attitude and a second open attitude.

JP-A-2020-55248 is an example of the related art.

However, when the opening and closing mechanism described in JP-A-2020-55248 is applied to a medium stacking device provided in a large format printer or the like, there is a problem that it is difficult to hold the upper unit in the second open attitude and it becomes easier to shift the upper unit from the first open attitude to a closed state at once. Specifically, in the medium stacking device for a large format printer, a portion corresponding to the upper unit is larger and heavier. Therefore, when an unintended strong external force acts in the first open attitude, the first open attitude may be released and the upper unit may be displaced in a direction to be closed. Concurrently, there is a possibility that the upper unit is not stopped in the second open attitude and is rapidly closed from the first open attitude. That is, there has been a demand for a medium stacking device that moderates displacement when the upper unit is closed.

### SUMMARY

A medium stacking device on which a medium ejected from a processing device in an ejection direction is stacked, the device includes a stacking portion that stacks the medium by a support surface extending in the ejection direction and supporting a part of the medium, a pressing portion that presses the medium supported by the support surface from above, and an upper unit that holds the pressing portion and is displaceable between a first open state and a second open state in which the pressing portion is separated from the support surface and a closed state in which the pressing portion is moved closer to face the support surface, wherein the upper unit has an arm including a convex portion, supported by the stacking portion, and configured to maintain the first open state and the second open state, the stacking portion has a cam groove in which a path that receives and guides the convex portion is formed, through which the convex portion moves when the upper unit is displaced between the first open state and second open state and the closed state, the cam groove is provided with a first concave portion that is entered by the convex portion, supports the entering convex portion from below, and maintains the upper unit in the first open state, and a second concave portion that maintains the upper unit in the second open state at a position lower than that in the first concave portion, and the second concave portion has higher acceptability than the first concave portion with respect to an impact from the convex portion.

### BRIEF DESCRIPTION OF THE DRAWINGS

FIG. 1 is a schematic diagram of a recording apparatus to which a medium stacking device according to an embodiment can be coupled.

FIG. 2 is a perspective view showing a state in which a medium stacking device and the recording apparatus are coupled.

FIG. 3 is a perspective view showing a configuration of the medium stacking device.

FIG. 4 is a side sectional view showing the configuration of the medium stacking device.

FIG. 5 is a perspective view showing configurations of a stacking portion and an upper unit.

FIG. 6 is a perspective view showing an attitude of the upper unit in a second open state.

FIG. 7 is a perspective view showing placements of an arm and an open holding portion.

FIG. 8 is a perspective view showing a configuration of the arm.

FIG. 9 is a perspective view showing the configuration of the arm.

FIG. 10 is a perspective view showing an appearance of a holding member.

FIG. 11 is a perspective view showing the appearance of the holding member.

FIG. 12 is a perspective view showing a configuration of the holding member.

FIG. 13 is a side view showing a detailed form of a second concave portion and a path for a convex portion.

FIG. 14 is a side view showing another form of the holding member.

FIG. 15 is a side view showing another form of the holding member.

FIG. 16 is a side view showing another form of the holding member.

FIG. 17 is a side view showing another form of the holding member.

### DESCRIPTION OF EMBODIMENTS

In the following embodiments, a medium stacking device 100 and a recording apparatus 10 which is a processing apparatus to which the medium stacking device 100 is applicable will be exemplified and described with reference to the drawings. The recording apparatus 10 is a large format type inkjet printer. The processing apparatus to which the medium stacking device of the present disclosure is applied is not limited to the large format type inkjet printer.

In each of the following drawings, X, Y, and Z axes are shown as coordinate axes orthogonal to one another as necessary, a direction indicated by an arrow is referred to as a +direction, and a direction opposite to the +direction is referred to as a-direction. When the recording apparatus 10 and the medium stacking device 100 are installed on a horizontal plane, the Z axis is along the vertical direction. The +Z direction may be referred to as upward, and the-Z direction may be referred to as downward. For convenience of illustration, a size of each member is different from an actual size.

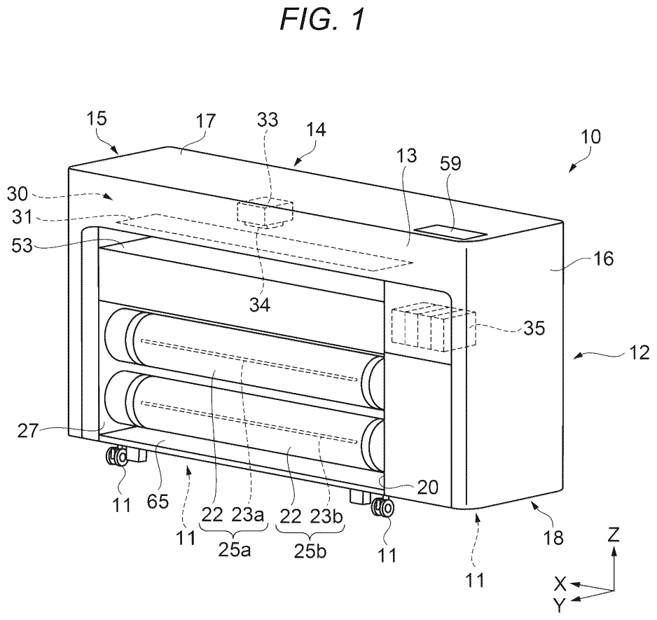

The recording apparatus 10 as a processing apparatus shown in FIG. 1 performs recording, that is, printing on media 22 wound around roll bodies 25a and 25b. The medium stacking device 100 described later is coupled to the recording apparatus 10 and stacks the media 22 on which printing has been performed and which are ejected from the recording apparatus 10.

The recording apparatus 10 includes a housing 12 as an exterior member. The housing 12 has a substantially rectangular parallelepiped shape that is longer in the direction along the X axis and higher in the direction along the Z axis. The housing 12 includes a front surface 13, a back surface 14, side surfaces 15 and 16, a top surface 17, and a bottom surface 18.

An input unit 59 is disposed in the −X direction and the +Y direction of the top surface 17 of the housing 12. A sheet ejection opening 53 and a roll body holder opening 27 are disposed in the front surface 13. Four leg portions 11 are provided in the bottom surface 18.

A recording unit 30, a supporting portion 31, and a medium holding unit 20 are disposed inside the housing 12. Although not illustrated, a conveyance path for the media 22, a frame as a framework of the recording apparatus 10, and a control unit are also disposed inside the housing 12. In the following description, the conveyance path for the media 22 in the recording apparatus 10 is also simply referred to as a conveyance path.

The conveyance path extends substantially in the −Y direction from the roll bodies 25a and 25b supported near the lower part of the front surface 13, and extends substantially upward along the back surface 14. The conveyance path is bent in the +Y direction in the near the upper part of the back surface 14, and continues to the sheet ejection opening 53 via the recording unit 30. The medium 22 is conveyed along the conveyance path by a plurality of conveying rollers (not illustrated), subjected to printing, and ejected from the sheet ejection opening 53.

The control unit includes a central processing unit (CPU), a system bus, a read only memory (ROM), a random access memory (RAM), and the like. The control unit is electrically coupled to each configuration of the recording apparatus 10 and integrally controls the operation of the recording apparatus 10. The recording apparatus 10 may be operated from information equipment such as a personal computer via the control unit.

The input unit 59 is, for example, a touch panel type liquid crystal display device. The input unit 59 is electrically coupled to the control unit. In the input unit 59, various instructions are input from an operator of the recording apparatus 10, and various types of information regarding the recording apparatus 10 is displayed. The input unit 59 may have a physical button. In the following description, the operator of the recording apparatus 10 and the medium stacking device 100 is also simply referred to as an operator.

The roll body holder opening 27 is a substantially rectangular opening corresponding to the two roll bodies 25a and 25b. The roll body holder opening 27 extends from the vicinity of the bottom surface 18 of the housing 12 to the middle of the height of the housing 12 in the direction along the Z axis and is longer than the lengths of the roll bodies 25a and 25b in the direction along the X axis. The roll bodies 25a and 25b are visually recognized from the +Y direction through the roll body holder opening 27.

In the roll body 25a, the medium 22 before printing is wound around a core member 23a. In the roll body 25b, the medium 22 before printing is wound around a core member 23b. The roll bodies 25a and 25b have substantially cylindrical shapes, and the height directions of the cylinders are along the X axis. The roll body 25b is disposed near the bottom surface 18 of the housing 12, and the roll body 25a is disposed above the roll body 25b. Examples of the medium 22 include paper such as coated paper, a resin sheet of polyvinyl chloride or the like, and fabric.

The dimension along the X axis, that is, the width of the medium 22 applicable to the recording apparatus 10 and the medium stacking device 100 is not particularly limited, but is, for example, from 16 inches to 44 inches.

The medium holding unit 20 holds the roll bodies 25a and 25b and supplies the media 22 before printing from the roll bodies 25a and 25b to the conveyance path. The medium 22 is conveyed from the medium holding unit 20 to the recording unit 30.

The recording unit 30 performs printing on the medium 22. The recording unit 30 is disposed near the top surface 17 and faces the supporting portion 31 in the direction along the Z axis. The supporting portion 31 is a so-called platen and is disposed below the recording unit 30. The recording unit 30 includes a carriage 33 and a recording head 34.

The carriage 33 holds the recording head 34. The carriage 33 is disposed in the upper part of the housing 12 and near the top surface 17. The carriage 33 is supported by the frame described above and driven by a carriage motor (not illustrated) to reciprocate along the X axis together with the recording head 34.

The recording head 34 ejects a liquid such as ink to cause the liquid to adhere to the medium 22. The recording head 34 is disposed in the lower part of the carriage 33. The recording head 34 has a nozzle surface (not illustrated) at a position facing the supporting portion 31.

A plurality of nozzle arrays are disposed on the nozzle surface. Each of the plurality of nozzle arrays includes a plurality of nozzles, and individually ejects an ink exhibiting a color such as cyan, magenta, yellow, or black. These inks are individually supplied from corresponding ink cartridges 35 to the recording head 34 via pipes (not illustrated). The recording head 34 may eject a liquid such as a clear ink or a treatment liquid in addition to the above-described inks of the respective colors.

In the recording head 34, piezoelectric elements are used as actuators which are drive units. The drive unit is not limited thereto. To the drive unit, for example, an electromechanical conversion element that displaces a vibrator plate as the actuator by electrostatic adsorption, or an electrothermal conversion element that ejects an ink or the like as droplets using air bubbles generated by heating may be applied.

The supporting portion 31 supports the medium 22 from below when printing is performed on the medium 22 by the recording head 34. The supporting portion 31 has a substantially rectangular shape elongated in the X direction, and is provided to correspond to a range in which the carriage 33 reciprocates.

The medium 22 is conveyed in the +Y direction while the recording head 34 reciprocates in the direction along the X axis together with the carriage 33. Concurrently, the ink or the like is caused to adhere to the medium 22 at a predetermined time from the recording head 34, thereby printing a desired image or the like on the medium 22.

Although not illustrated, a cutting unit is disposed in the +Y direction of the supporting portion 31. The cutting unit cuts the medium 22 along the X axis. The medium 22 is cut from a belt shape into a single sheet shape by the cutting unit.

In the sheet ejection opening 53, the medium 22 on which printing has been performed is ejected substantially in the +Y direction. The sheet ejection opening 53 is disposed above the roll body holder opening 27 and in the +Y direction of the cutting unit. The sheet ejection opening 53 is a slit elongated in the direction along the X axis to correspond to the width as the dimension of the medium 22 along the X axis.

The four leg portions 11 are wheel casters. The four leg portions 11 support the recording apparatus 10 from below and facilitate the movement of the recording apparatus 10 by the wheels.

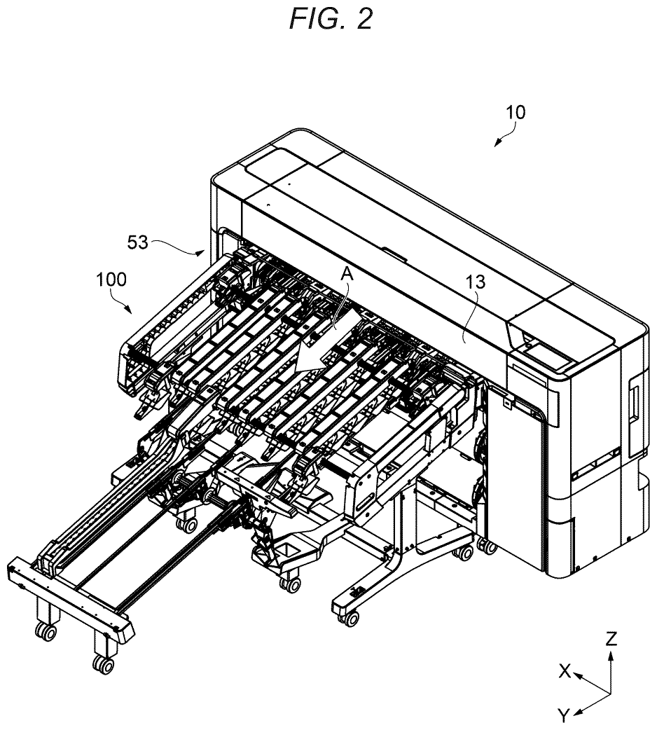

As shown in FIG. 2, the medium stacking device 100 according to the present embodiment is coupled to the sheet ejection opening 53 of the recording apparatus 10 from the +Y direction. The medium 22 (not illustrated) ejected from the recording apparatus 10 in the ejection direction is stacked on the medium stacking device 100.

Although not illustrated, the medium stacking device 100 and the recording apparatus 10 may be positioned and coupled to each other by coupling coupling members respectively provided therein.

Here, the ejection direction of the medium 22 from the sheet ejection opening 53 is referred to as an A direction. The A direction coincides with the +Y direction when viewed from above and is orthogonal to the X axis. The A direction forms a depression angle when viewed from the recording apparatus 10, and is a direction in which the height decreases toward the +Y direction.

When a plurality of media 22 subjected to printing by the recording apparatus 10 and cut into single sheets by the cutting unit are continuously ejected, the media 22 ejected from the sheet ejection opening 53 are automatically and sequentially stacked on the medium stacking device 100. By applying the medium stacking device 100, it becomes unnecessary for the operator to pick up the medium 22 ejected from the recording apparatus 10 at each time, and the convenience is improved.

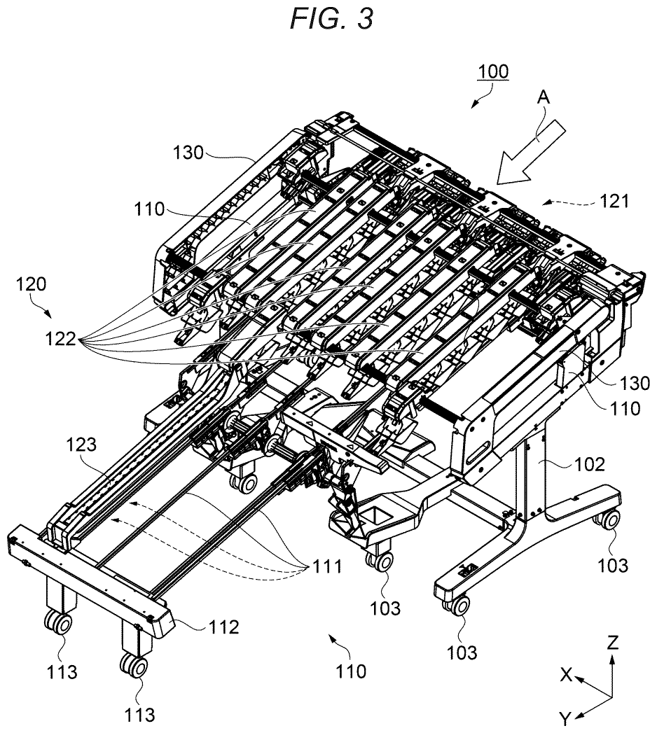

As shown in FIG. 3, the medium stacking device 100 includes a frame member 102, a stacking portion 110, a pressing portion 120, and an upper unit 130.

The frame member 102 is a structural member of the medium stacking device 100. The frame member 102 supports the stacking portion 110. The upper unit 130 is supported by the stacking portion 110 and holds the pressing portion 120. The stacking portion 110 is disposed below the pressing portion 120. The frame member 102 is formed by assembling sheet metal parts, tubular parts, and the like. A plurality of leg portions 103 are provided below the frame member 102.

The plurality of leg portions 103 are wheel casters. The plurality of leg portions 103 support the medium stacking device 100 from below and facilitate the movement of the medium stacking device 100 by the wheels.

The stacking portion 110 stacks the medium 22 ejected in the A direction. The stacking portion 110 includes a plurality of support members 111, a beam member 112, and two leg portions 113.

The plurality of support members 111 support the medium 22 from below. Each support member 111 is a substantially rod-shaped member elongated in the A direction. The plurality of support members 111 are arranged side by side in the direction along the X axis. Each support member 111 is, for example, a metal member having a rectangular section.

Although not illustrated, the support members 111 are also disposed below pressing members 122. Four support members 111 are disposed in a region not overlapping the pressing members 122 in the direction along the Z axis, in other words, a region protruding in the +Y direction from the pressing members 122 when viewed from above. The ends of the four support members 111 in the A direction are fixed to the beam member 112.

The plurality of support members 111 have uneven height positions, which are positions in the direction along the Z axis, when viewed from the A direction. Therefore, when the medium 22 is stacked on the stacking portion 110, the center of the medium 22 in the width direction is easily curved in a convex shape upward when viewed from the A direction. Since the medium 22 is wound in a roll shape before printing, the medium may have a curl. Since the curl is not eliminated even when cut into a single sheet, the curl is eased by curving in a direction different from the curl as described above.

The beam member 112 supports the four support members 111 to suppress deflection. The beam member 112 also has a function of aligning the positions of the media 22 in the A direction by coming into contact with the leading ends of the media 22 in the A direction. The beam member 112 is a substantially rod-shaped member elongated in the direction along the X axis. The two leg portions 113 are disposed below the beam member 112.

The upper unit 130 is displaced, that is, changes its attitude with respect to the stacking portion 110 while holding the pressing portion 120. The upper unit 130 is a substantially frame-shaped member when viewed from above, and holds the pressing portion 120 in the frame. The attitude change of the upper unit 130 will be described later.

The pressing portion 120 presses the medium 22 from above when the medium stacking device 100 stacks the medium 22. The pressing portion 120 has upstream flaps 121 and pressing members 122 and 123. A plurality of upstream flaps 121, the pressing members 122, and the pressing member 123 are arranged in this order in the A direction. The plurality of upstream flaps 121 and the pressing members 122 and 123 are located above the medium 22 when the medium stacking device 100 stacks the medium 22.

The pressing member 122 is a substantially rod-shaped member elongated in the A direction. Six pressing members 122 are arranged side by side in the direction along the X axis.

The pressing member 123 is a single substantially rod-shaped member elongated in the A direction. The pressing member 123 is supported at the end of one of the pressing members 122 in the A direction. The pressing member 123 can rotate clockwise from the state shown in FIG. 3 about a support position by the pressing member 122 when viewed from the −X direction. By rotating and folding the pressing member 123 toward the pressing member 122, the dimension of the pressing portion 120 in the direction along the Y axis is reduced.

The two leg portions 113 are wheel casters. The two leg portions 113 support the beam member 112 from below and facilitate the movement of the medium stacking device 100 by the wheels. The four support members 111 and the beam member 112 can move in the-Y direction relative to the frame member 102 from the state illustrated in FIG. 3. That is, the four support members 111 are folded and stored together with the beam member 112 at the lower side than the support member 111 located below the pressing member 122. Then, the two leg portions 113 facilitate the movement in the −Y direction. Further, by folding the pressing member 123 and storing the four support members 111, the occupied area of the medium stacking device 100 can be reduced. Note that the four support members 111 and the beam member 112 may be retracted and stored below the pressing member 122.

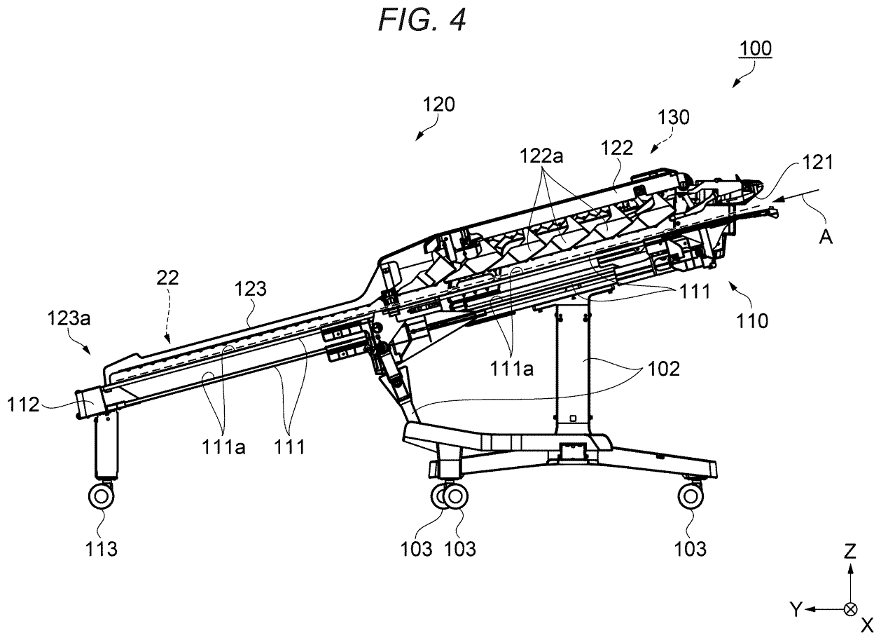

As shown in FIG. 4, each support member 111 includes a support surface 111a that supports a part of the medium 22. The support surface 111a is an upper surface of the support member 111 and extends in the A direction as the ejection direction. Here, in FIG. 4, a movement path and a stacking position of the medium 22 in the medium stacking device 100 are indicated by a broken line. The movement path of the medium 22 is along the A direction. The movement path of the medium 22 is located between the pressing portion 120 and the stacking portion 110 when viewed from the −X direction. In the movement path of the medium 22, the side at which the medium moves in the A direction is referred to as downstream, and the side at which the medium moves opposite to the A direction is referred to as upstream.

The position along the Z axis of the support surface 111a of each support member 111, that is, the height is lower at downstream than at upstream in the A direction. Therefore, when the medium 22 is stacked on the medium stacking device 100, the medium 22 easily slides down from upstream to downstream due to gravity.

The upstream flap 121 is disposed above the start point of the movement path of the medium 22. The medium 22 introduced into the medium stacking device 100 is first pressed from above by the upstream flap 121. Three upstream flaps 121 are arranged along the X axis.

Each pressing member 122 includes a plurality of movable portions 122a. The plurality of movable portions 122a are arranged along the A direction. The upper end of each movable portion 122a is supported by the pressing member 122 and is pivotable about a position supported by the pressing member 122 when viewed from the −X direction. As a result, the lower end of each movable portion 122a comes into contact with the medium 22 to press the medium 22 from above and pivots, thereby adjusting the pressure against the medium 22.

The pressing member 123 has a rib portion 123a at the end in the A direction. The rib portion 123a protrudes downward. The rib portion 123a comes into contact with the leading end of the medium 22 in the A direction together with the beam member 112 to align a leading end position of the medium 22 in the A direction.

The medium 22 is ejected in the A direction, is introduced into the medium stacking device 100, slides down in the A direction along a plurality of support surfaces 111a, and is stacked. In this regard, the medium 22 supported by each support surface 111a is first pressed from above by the plurality of upstream flaps 121. Then, the medium 22 is pressed from above sequentially by the pressing members 122 and the pressing member 123. In this manner, the pressing portion 120 presses the medium 22, which is supported from below by each support surface 111a, from above.

As a result, the movement path of the medium 22 is guided in the A direction, and the curl of the medium 22 described above is eased. When the degree of the curl of the medium 22 is slight or when the number of media 22 stacked on the medium stacking device 100 is small, the medium 22 may not come into contact with the upstream flaps 121 or the pressing members 122 and 123.

Here, an attitude in which the upper unit 130 causes the pressing portion 120 to move closer and face the support surface 111a, that is, a state illustrated in FIG. 4 is a closed state of the upper unit 130. The pressing portion 120 presses the medium 22 in the closed state.

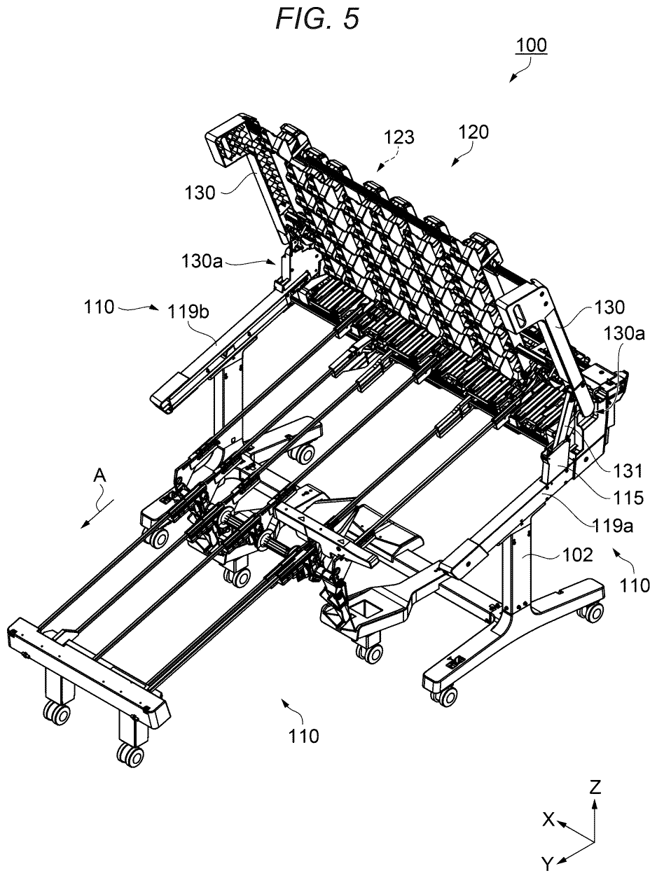

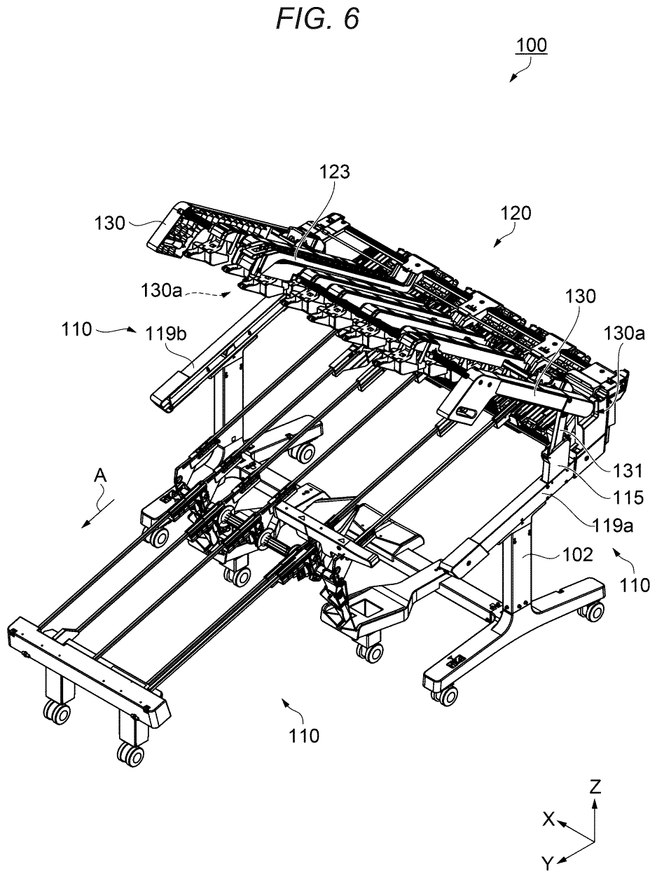

As shown in FIGS. 5 and 6, the upper unit 130 is opened from the closed state described above such that the end in the A direction is positioned upward, and the attitude changes. FIG. 5 shows a first open state in which the upper unit 130 is opened to the maximum. FIG. 6 shows a second open state in which the upper unit 130 is closed to an intermediate position from the first open state to the closed state. That is, the upper unit 130 can be displaced between the first open state and second open state in which the pressing portion 120 is separated from the support surface 111a and the closed state.

In FIGS. 5 and 6, the pressing member 123 is folded to overlap with the pressing member 122. It is preferable that, when the upper unit 130 is set in the first open state and the second open state, the pressing member 123 is folded in advance.

By setting the upper unit 130 in the first open state and the second open state, the work of picking up the medium 22 stacked on the stacking portion 110 is facilitated. In addition, when the first open state is changed to the closed state, the upper unit 130 and the pressing portion 120 are prevented from being unintentionally and rapidly closed through the second open state.

The stacking portion 110 has substantially rod-shaped structural members 119a and 119b elongated in the A direction, and an open holding portion 115. When the medium stacking device 100 is viewed from above, the structural member 119a is disposed on the end side in the −X direction along the Y axis, and the structural member 119b is disposed on the end side in the +X direction along the Y axis. The structural members 119a and 119b are supported by the frame member 102 from below at substantially the center in the A direction when viewed from the −X direction.

Each of the structural members 119a and 119b supports pivot shafts 130a of the upper unit 130, which will be described later, near the end in a direction opposite to the A direction. The open holding portion 115 is disposed slightly in the A direction with respect to the position where the structural member 119a supports the pivot shaft 130a. Although the details will be described later, the open holding portion 115 specifies the above-described attitude change of the upper unit 130.

The upper unit 130 has a pair of the pivot shafts 130a and an arm 131. Each of the pivot shafts 130a is disposed near the end in the direction opposite to the A direction for each of the structural members 119a and 119b. The arm 131 is disposed to correspond to the open holding portion 115.

The respective pivot shafts 130a are pivotably supported by the structural members 119a and 119b. Therefore, the upper unit 130 pivots clockwise and counterclockwise about the pivot shafts 130a when viewed from the −X direction, and the attitude changes between the first open state and second open state and the closed state.

The arm 131 supports the main body of the upper unit 130 at a substantially upper end and engages with the open holding portion 115 in a substantially lower part. The arm 131 can maintain the main body of the upper unit 130 in the first open state and the second open state by engaging with the open holding portion 115. Although the details will be described later, the arm 131 serves to change the attitude of the upper unit 130 together with the open holding portion 115.

Here, in the medium stacking device 100, in order to reduce the weight and simplify the structure, the arm 131 and the open holding portion 115 are disposed only at one side in the −X direction. Since the upper unit 130 is cantilevered, in the configuration of the related art, when closed from the first open state to the second open state, it is difficult to stop the upper unit in the second open state, and it may be possible to shift the upper unit to the closed state at once.

Specifically, since the arm 131 and the open holding portion 115 are not disposed in the +X direction of the upper unit 130, the inertial force of falling is less likely to be attenuated at the +X direction side of the upper unit 130 when the first open state is changed to the second open state. In particular, in a situation where the operator does not hold and close the upper unit 130 by hand, but the upper unit 130 falls by its own weight, the inertial force increases.

Therefore, at the +X direction side of the upper unit 130, the upper unit tends to further shift from the second open state to the closed attitude. This reaction reaches the −X direction side of the upper unit 130 and acts on the arm 131 and the open holding portion 115. As a result, the second open state is not maintained, and the upper unit 130 may be rapidly closed. The rapid shift to the closed state may cause a failure such as breakage of a component. In contrast, the medium stacking device 100 of the present embodiment reliably maintains the second open state by changing the configuration of the open holding portion 115.

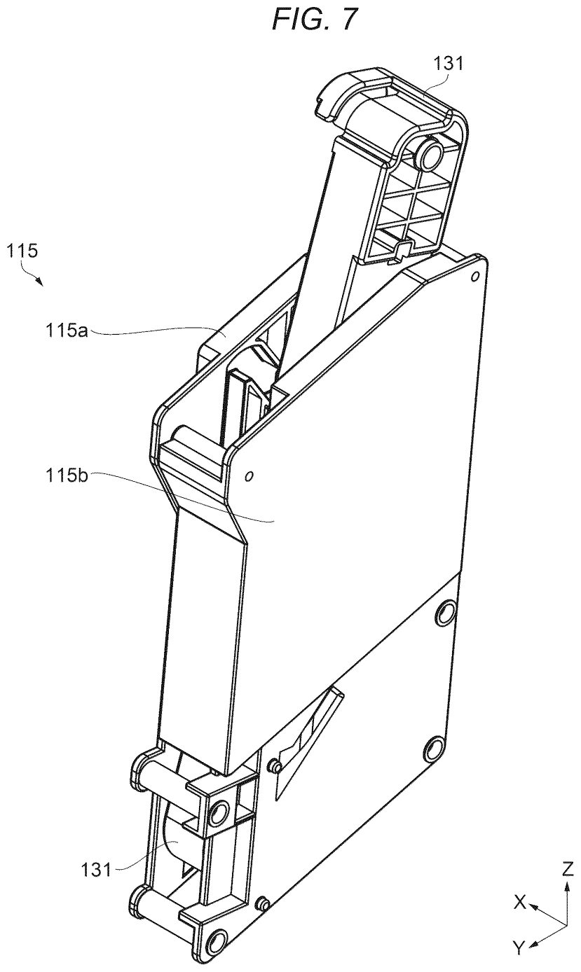

As shown in FIG. 7, the open holding portion 115 includes holding members 115a and 115b. Each of the holding members 115a and 115b is a substantially plate-shaped member, and the principal surface thereof is along the YZ plane. The principal surfaces of the holding member 115a and the holding member 115b are separated from each other in the direction along the X axis, and a space is provided inside.

The arm 131 partially enters the space and engages with the open holding portion 115. FIG. 7 shows the placements of the open holding portion 115 and the arm 131 when the upper unit 130 is in the closed state.

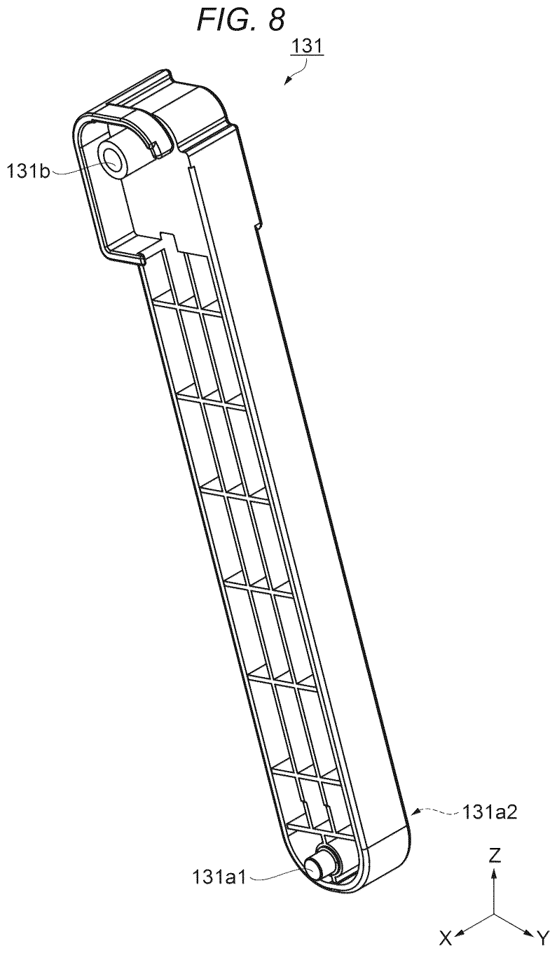

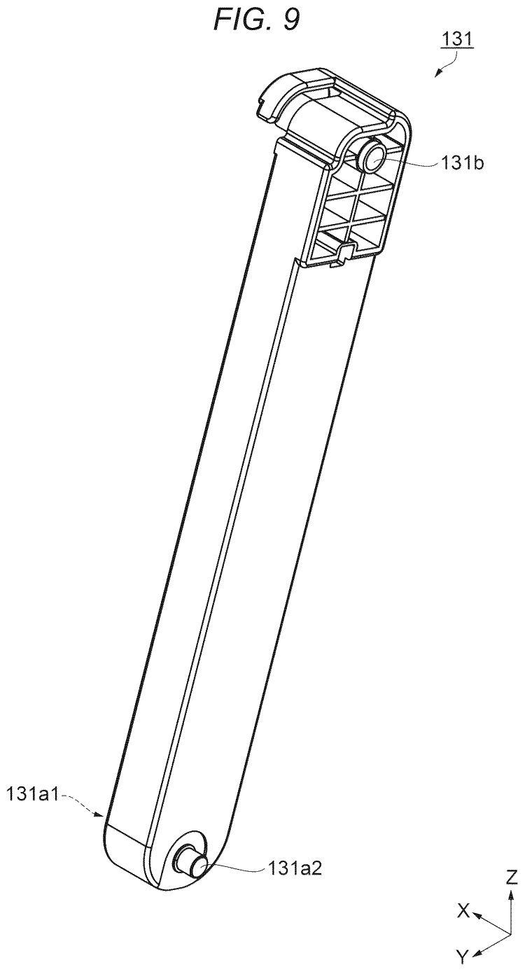

As shown in FIGS. 8 and 9, the arm 131 includes convex portions 131a1 and 131a2 and a bearing portion 131b. In the attitude shown in FIGS. 8 and 9, the arm 131 is a rod-shaped member elongated in the substantially vertical direction.

The convex portions 131a1 and 131a2 are disposed at substantially lower ends of the arm 131. The convex portion 131a1 is a cylindrical member protruding in the +X direction, and the convex portion 131a2 is a cylindrical member protruding in the −X direction. The convex portions 131a1 and 131a2 engage with a cam groove, which will be described later, of the open holding portion 115 and is supported by the open holding portion 115. That is, the open holding portion 115 supports the main body of the upper unit 130 via the arm 131.

The bearing portion 131b is disposed at a substantially upper end of the arm 131. The bearing portion 131b is a cylindrical cavity penetrating the arm 131 in the direction along the X axis. A shaft fixed to the main body of the upper unit 130 is fitted into the cavity. The bearing portion 131b rotatably supports the shaft. The arm 131 is attached to the upper unit 130 in a hanging state by the shaft fitted into the bearing portion 131b. As described above, the main body of the upper unit 130 is supported by the structural member 119a via the pivot shaft 130a, and is also supported by the structural member 119a via the open holding portion 115 and the arm 131.

The upper unit 130 pivots about the pivot shaft 130a located in the-Y direction with respect to the bearing portion 131b. Therefore, as the upper unit 130 pivots and is displaced to open away from the stacking portion 110, the bearing portion 131b moves in the −Y direction from the position in the closed state. At this time, in the present embodiment, the bearing portion 131b is located in the −Y direction with respect to the open holding portion 115, and the convex portions 131a1 and 131a2 engaged with a cam groove 1150 of the open holding portion 115 is located in the +Y direction with respect to the bearing portion 131b. Therefore, when viewed from the −X direction, the arm 131 tend to pivot counterclockwise about the bearing portion 131b, and the convex portions 131a1 and 131a2 moving in the cam groove 1150 tend to move in the −Y direction.

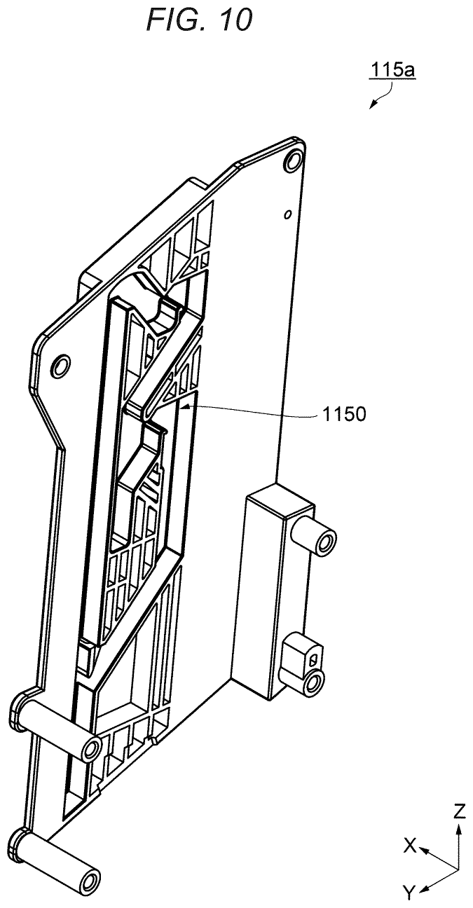

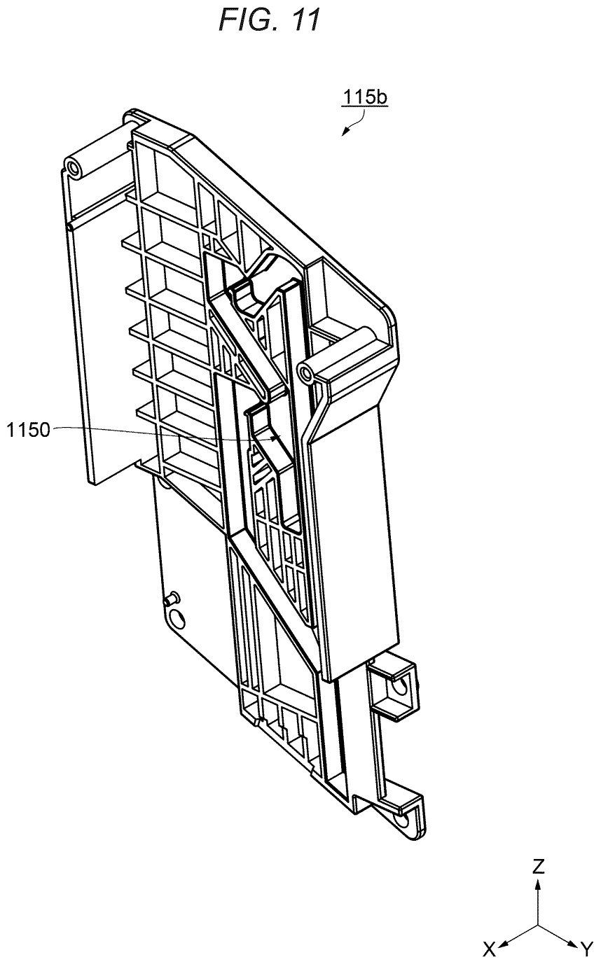

As shown in FIGS. 10 and 11, each of the holding members 115a and 115b has the cam groove 1150. The cam groove 1150 of the holding member 115a is disposed on the principal surface facing the −X direction. The cam groove 1150 of the holding member 115b is disposed on the principal surface facing the +X direction. That is, when the holding member 115a and the holding member 115b are assembled, each cam groove 1150 faces the internal space. Accordingly, in the arm 131, the convex portion 131a1 corresponds to the cam groove 1150 of the holding member 115a, and the convex portion 131a2 corresponds to the cam groove 1150 of the holding member 115b. The holding member 115a and the holding member 115b are assembled by, for example, a plurality of screws.

The cam groove 1150 of the holding member 115a and the cam groove 1150 of the holding member 115b are in plane symmetry with respect to a plane along the YZ plane. Therefore, in the following description of the cam groove 1150, the cam groove 1150 of the holding member 115a will be described, and the description of the cam groove 1150 of the holding member 115b will be omitted.

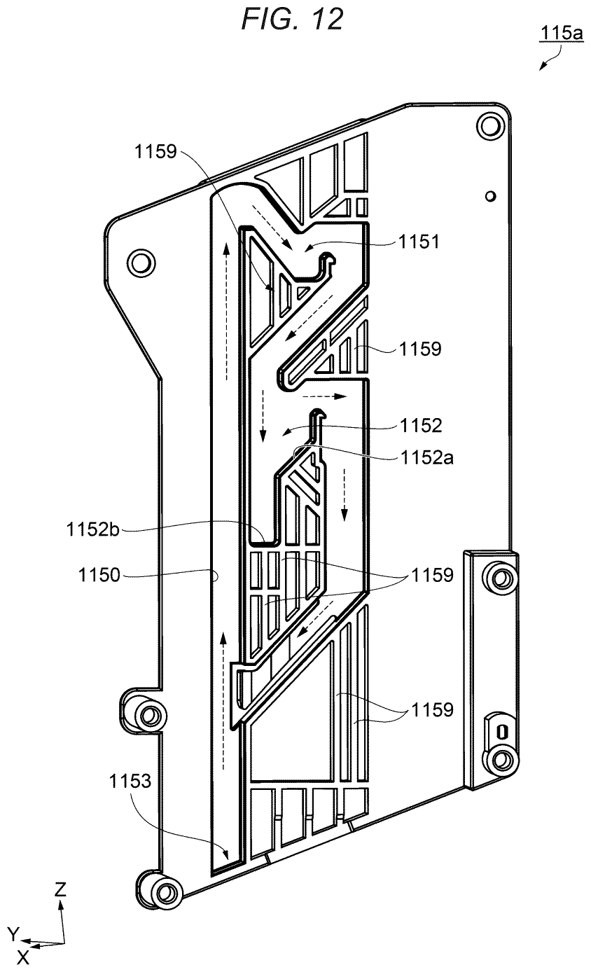

As shown in FIG. 12, the cam groove 1150 is recessed in the +X direction. A path for receiving and guiding the convex portion 131a1 is formed in the cam groove 1150. In FIG. 12, the path of the convex portion 131a1 is indicated by dashed arrows. As described above, when the upper unit 130 is displaced to the first open state, the second open state, and the closed state, the convex portion 131a1 moves along the path.

When the convex portion 131a1 moves along the path, the position of the convex portion 131a1 in the vertical direction changes. As a result, the position of the arm 131 in the vertical direction shown in FIGS. 8 and 9 also changes, and the bearing portion 131b is displaced up and down. The bearing portion 131b supports the main body of the upper unit 130. Therefore, due to the vertical displacement of the bearing portion 131b with the movement of the convex portion 131a1 along the path, the upper unit 130 pivots about the pivot shaft 130a and the attitude changes. That is, as the convex portion 131a1 moves along the path while being guided by the cam groove 1150, the upper unit 130 changes its attitude to the first open state, the second open state, and the closed state.

The cam groove 1150 is provided with a first concave portion 1151, a second concave portion 1152, and a third concave portion 1153. The first concave portion 1151, the second concave portion 1152, and the third concave portion 1153 are disposed in the path of the convex portion 131a1. The first concave portion 1151, the second concave portion 1152, and the third concave portion 1153 are recesses that recess substantially in the-Z direction, and the convex portion 131a1 enters the concave portions from substantially above and the concave portions support the entering convex portion 131a1 from below.

The first concave portion 1151 corresponds to the first open state, the second concave portion 1152 corresponds to the second open state, and the third concave portion 1153 corresponds to the closed state. That is, the upper unit 130 is maintained in the first open state by the first concave portion 1151, is maintained in the second open state by the second concave portion 1152, and is maintained in the closed state by the third concave portion 1153.

In the vertical direction, the third concave portion 1153 is the lowest, and the first concave portion 1151 is the highest. The second concave portion 1152 supports the convex portion 131a1 at a position lower than the first concave portion 1151, and maintains the upper unit 130 in the second open state. Therefore, in the second open state, the upper unit 130 is slightly closed with respect to the first open state.

When the third concave portion 1153 is a starting point of the path of the convex portion 131a1, the path is routed sequentially from the third concave portion 1153 through the first concave portion 1151 and the second concave portion 1152 and returned to the third concave portion 1153.

The holding member 115a includes a plurality of ribs 1159. The plurality of ribs 1159 are disposed at positions around the cam groove 1150 including the downside of the second concave portion 1152. Each rib 1159 extends in the vertical direction and protrudes in the −X direction. The plurality of ribs 1159 increase the mechanical strength of the cam groove 1150 against an impact or an external force generated when the convex portion 131a1 moves along the path.

In the present embodiment, the configuration in which the arm 131 includes the convex portions 131a1 and 131a2 and each of the holding members 115a and 115b includes the cam groove 1150 is exemplified, but the present disclosure is not limited thereto. For example, only one of the convex portions 131a1 and 131a2 and only the corresponding cam groove 1150 may be provided.

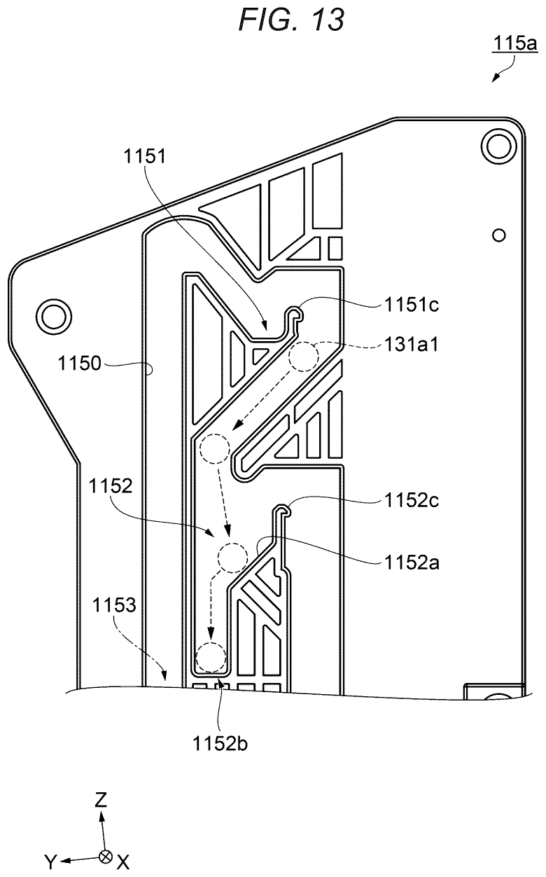

As shown in FIG. 13, the first concave portion 1151 is disposed in the upper part of the cam groove 1150. To change the upper unit 130 from the closed state to the first open state, the operator lifts the upper unit 130. Accordingly, the convex portion 131a1 moves upward from the third concave portion 1153, reaches the highest position in the cam groove 1150, and then falls in the −Y direction and downward and enters the first concave portion 1151. A wall portion 1151c of the first concave portion 1151 is provided, and thus the convex portion 131a1 is less likely to be detached from the first concave portion 1151 and the first open state is easily maintained.

To change the upper unit 130 from the first open state to the second open state, the operator slightly lifts the upper unit 130. Accordingly, the convex portion 131a1 comes out of the first concave portion 1151 over the wall portion 1151c and moves to the second concave portion 1152. Here, in the cam groove 1150, the height of the upper part of the wall portion 1151c is lower than the highest position described above. Therefore, the level difference from the position where the convex portion exits from the first concave portion 1151 to the second concave portion 1152 is reduced.

After the convex portion 131a1 exits from the first concave portion 1151, the upper unit 130 tends to be closed due to gravity, and it is preferable for the upper unit 130 to shift to the second open state while being supported by the operator by hand. However, with the configuration described below, even when not supported by hand, it is less likely for the upper unit 130 to rapidly shift to the closed state.

The convex portion 131a1 moves over the wall portion 1151c of the first concave portion 1151, and then slides down obliquely downward along the cam groove 1150. Then, in the upper part of the second concave portion 1152, the convex portion substantially downward away from a wall of the cam groove 1150. Here, since the pivot shaft 130a (not illustrated) as the fulcrum of the displacement of the upper unit 130 is in the −Y direction, the convex portion 131a1 falls downward and slightly in the −Y direction along a virtual circumference centered on the pivot shaft 130a.

The second concave portion 1152 has an inclined surface 1152a, a bottom portion 1152b, and a wall portion 1152c. The inclined surface 1152a, the bottom portion 1152b, and the wall portion 1152c are disposed to face the cam groove 1150. In FIG. 13, the path of the movement of the convex portion 131a1 when the upper unit shifts from the first open state to the second open state is indicated by dashed arrows.

The second concave portion 1152 has higher acceptability than the first concave portion 1151 with respect to the impact received from the falling convex portion 131a1. Here, the impact acceptability is a property of relaxing an impact. The height difference from the position where the convex portion exits from the first concave portion 1151 to the second concave portion 1152 is larger than the height difference from the highest position to the first concave portion 1151. Therefore, in the second concave portion 1152, the acceptability of the impact due to the fall of the upper unit 130, that is, the convex portion 131a1 is enhanced.

Specifically, the second concave portion 1152 has an impact absorbing portion. When the upper unit 130 is suddenly closed from the first open state by an external force or the like, or when the operator releases his/her hand from the upper unit 130 after the convex portion exits from the first concave portion 1151, the impact is attenuated by the impact absorbing portion. Therefore, the convex portion 131a1 is less likely to be detached from the second concave portion 1152, and the upper unit 130 is more easily held in the second open state.

In this embodiment, the impact absorbing portion is the inclined surface 1152a that narrows the width of the path along the Y axis toward the bottom portion 1152b of the second concave portion 1152. As described above, the convex portion 131a1 moves toward the second concave portion 1152 while falling downward and slightly in the −Y direction. Therefore, the convex portion 131a1 first comes into contact with the inclined surface 1152a. The inclined surface 1152a guides the convex portion 131a1 downward and slightly in the +Y direction, not downward and slightly in the −Y direction. Therefore, the convex portion 131a1 slides on the inclined surface 1152a, and the impact of the fall of the upper unit 130 is relaxed. Accordingly, the convex portion 131a1 is less likely to be detached from the second concave portion 1152. The momentum of the convex portion 131a1 becomes lower while the convex portion is sliding down the inclined surface 1152a, and the convex portion further moves downward and stops at the bottom portion 1152b.

The bottom portion 1152b is disposed at the lowest position in the second concave portion 1152. The bottom portion 1152b supports the convex portion 131a1 from below. Thus, the upper unit 130 is held in the second open state.

The wall portion 1152c is disposed in the −Y direction of the inclined surface 1152a. Accordingly, the convex portion 131a1 is less likely to be detached from the second concave portion 1152, and the convex portion 131a1 in contact with the inclined surface 1152a is easily guided to the second concave portion 1152.

In the second concave portion 1152, from below of the inclined surface 1152a to the bottom portion 1152b, the width of the path along the Y axis is narrower than that in the other regions of the cam groove 1150. Specifically, in the path extending upward from the third concave portion 1153, which is the other region of the cam groove 1150, the width is not particularly limited, but is set to, for example, about 7 mm. The convex portion 131a1 is substantially circular and has a diameter of slightly less than 6 mm. In contrast, around the bottom portion 1152b, the width is set to slightly more than 6 mm. Therefore, when the convex portion 131a1 moves from the inclined surface 1152a to the bottom portion 1152b, sliding resistance is likely to occur, and the impact of the fall is further relaxed.

The second concave portion 1152 is deeper than the first concave portion 1151 in the vertical direction. Specifically, the depth of the second concave portion 1152 from the wall portion 1152c to the bottom portion 1152b is greater than the depth of the first concave portion 1151 from the wall portion 1151c to a bottom portion (not illustrated). Accordingly, the convex portion 131a1 is even less likely to be detached from the second concave portion 1152.

To change the upper unit 130 from the second open state to the closed state, the operator lifts the upper unit 130 until the convex portion 131a1 moves over the wall portion 1152c. After exiting from the second concave portion 1152 over the wall portion 1152c, the convex portion 131a1 can move along the path extending downward. As a result, the upper unit 130 shifts to the closed state.

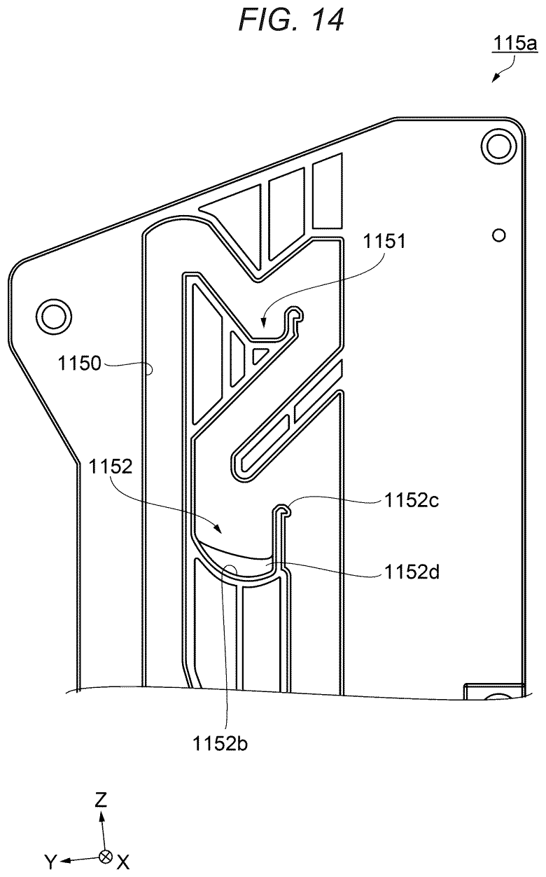

Hereinafter, other forms of the holding member 115a will be described with reference to FIGS. 14 to 17. FIGS. 14 to 17 are different in detailed forms. In the following description, the same signs are used for the same configurations as those in the above-described form, and the overlapping description will be omitted. Any two or more of the above-described form and the respective following forms may be combined.

As shown in FIG. 14, in the holding member 115a in the other form, the second concave portion 1152 does not have the inclined surface 1152a and is shallow in the vertical direction, unlike the above-described form. The second concave portion 1152 in the form is provided with an impact absorbing member 1152d as an impact absorbing portion.

The impact absorbing member 1152d is disposed in contact with the bottom portion 1152b at the upside. The impact absorbing member 1152d is formed of a material having elasticity and impact absorbing properties such as rubber, elastomer, and sponge. Accordingly, when the convex portion 131a1 rapidly moves to the second concave portion 1152, the impact is absorbed and attenuated by the impact absorbing member 1152d. Therefore, the convex portion 131a1 is less likely to be detached from the second concave portion 1152.

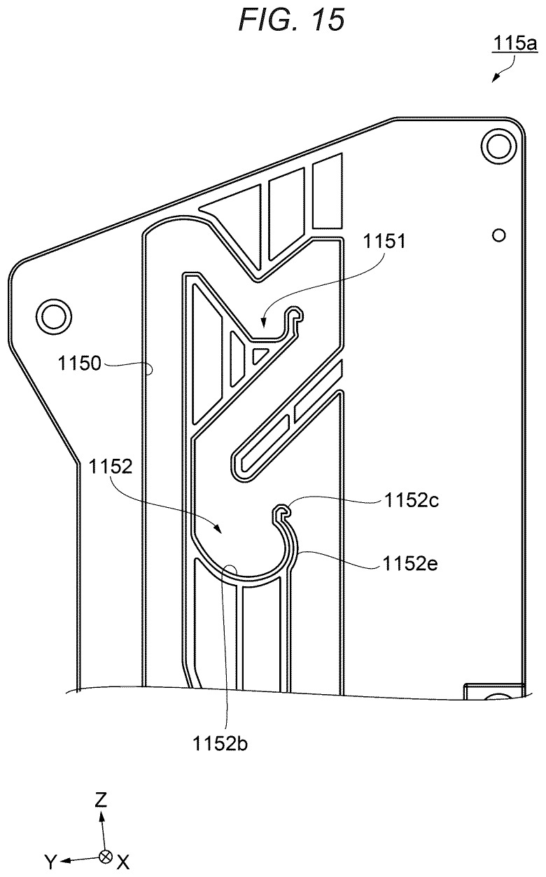

As shown in FIG. 15, in the holding member 115a in the other form, the second concave portion 1152 does not have the inclined surface 1152a and is shallow in the vertical direction. The second concave portion 1152 in the form has a hook-shaped portion 1152e. The hook-shaped portion 1152e is disposed in the lower part of the wall portion 1152c and in the −Y direction of the bottom portion 1152b.

The hook-shaped portion 1152e is formed with a curved part of the base of the wall portion 1152c, and has a curved surface continuous with the bottom portion 1152b. Therefore, when the convex portion 131a1 moves to the second concave portion 1152 so as to fall, the convex portion is likely to stay in the second concave portion 1152 by the hook-shaped portion 1152e. Accordingly, the convex portion 131a1 is less likely to be detached from the second concave portion 1152.

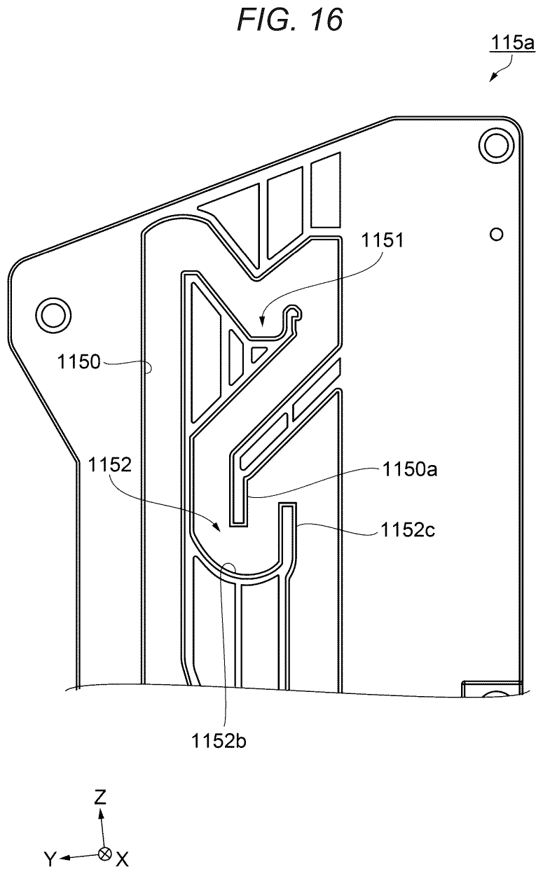

As shown in FIG. 16, in the holding member 115a in the other form, the second concave portion 1152 does not have the inclined surface 1152a and is shallow in the vertical direction. The cam groove 1150 in the form has a protruding portion 1150a protruding toward the bottom portion 1152b of the second concave portion 1152. In the vertical direction, the lower end of the protruding portion 1150a is located to be lower than the upper end of the wall portion 1152c. When viewed from the Y direction, the protruding portion 1150a and the wall portion 1152c partially overlap each other. Since the protruding portion 1150a protrudes from above the bottom portion 1152b toward the bottom portion 1152b, the movement of the convex portion 131a1 downward and slightly in the −Y direction is restricted, and the convex portion is less likely to be detached from the second concave portion 1152.

Since the protruding portion 1150a restricts the movement of the convex portion 131a1 inside and around the second concave portion 1152, the wall portion 1152c shifted in the −Y direction. Accordingly, the operability when the convex portion 131a1 is lifted from the second concave portion 1152 and the upper unit 130 is changed from the second open state to the closed state is ensured.

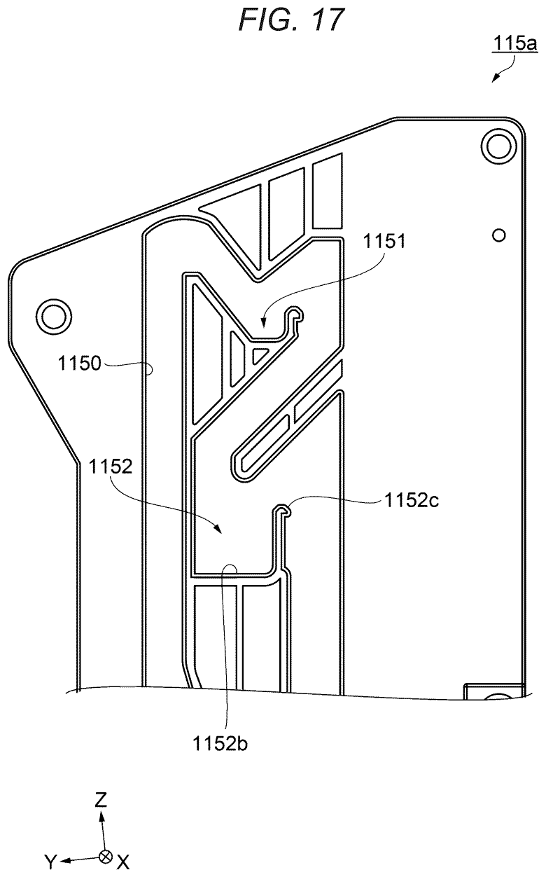

As shown in FIG. 17, in the holding member 115a in the other form, the second concave portion 1152 does not have the inclined surface 1152a and is shallow in the vertical direction. A flat bottom portion 1152b is disposed along the XY plane in the second concave portion 1152 of the form. Since the bottom portion 1152b is not a curved surface, when the convex portion 131a1 moves to the second concave portion 1152, the convex portion easily comes into contact with the bottom portion 1152b before the wall portion 1152c. Therefore, it is difficult for the convex portion 131a1 to move over the wall portion 1152c and to be detached from the second concave portion 1152.

According to the present embodiment, the following effects can be obtained.

The shift of the upper unit 130 from the first open state to the closed state can be made moderate. Specifically, the upper unit 130 is closed after being displaced from the first open state via the second open state to the closed state. Concurrently, the convex portion 131a1 moves through the second concave portion 1152. The second concave portion 1152 has higher impact acceptability than the first concave portion 1151, and the convex portion 131a1 is less likely to be detached from the second concave portion 1152. Accordingly, the upper unit 130 is easily held in the second open state, and is less likely to be rapidly displaced from the first open state to the closed state. Therefore, it is possible to provide the medium stacking device 100 that moderately shifts the upper unit 130 from the first open state to the closed state.

What is claimed is:

1. A medium stacking device on which a medium ejected from a processing device in an ejection direction is stacked, the device comprising:
a stacking portion that stacks the medium by a support surface extending in the ejection direction and supporting a part of the medium;
a pressing portion that presses the medium supported by the support surface from above; and
an upper unit that holds the pressing portion and is displaceable between a first open state and a second open state in which the pressing portion is separated from the support surface and a closed state in which the pressing portion is moved closer to face the support surface, wherein the upper unit has an arm including a convex portion, supported by the stacking portion, and configured to maintain the first open state and the second open state,
the stacking portion has a cam groove in which a path that receives and guides the convex portion is formed, through which the convex portion moves when the upper unit is displaced between the first open state and second open state and the closed state,
the cam groove is provided with a first concave portion that is entered by the convex portion, supports the entering convex portion from below, and maintains the upper unit in the first open state, and a second concave portion that maintains the upper unit in the second open state at a position lower than that in the first concave portion, and
the second concave portion has higher acceptability than the first concave portion with respect to an impact from the convex portion.

2. The medium stacking device according to claim 1, wherein
the second concave portion has an impact absorbing portion.

3. The medium stacking device according to claim 2, wherein
the impact absorbing portion is an inclined surface that narrows a width of the path toward a bottom portion of the second concave portion.

4. The medium stacking device according to claim 2, wherein
the impact absorbing portion is an impact absorbing member disposed in a bottom portion of the second concave portion.

5. The medium stacking device according to claim 1, wherein
the second concave portion has a hook-shaped portion.

6. The medium stacking device according to claim 1, wherein
a width of the path in the second concave portion is narrower than that of another region of the cam groove.

7. The medium stacking device according to claim 1, wherein
the second concave portion is deeper than the first concave portion in a vertical direction.

8. The medium stacking device according to claim 1, wherein
the cam groove has a protruding portion protruding toward a bottom portion of the second concave portion.
